(19) United States
(12) Patent Application Publication
(10) Pub. No.: US 2008/0138082 A1
(43) Pub. Date: Jun. 12, 2008

(54) APPARATUS AND METHOD FOR GENERATING OPTICAL RETURN-TO-ZERO SIGNAL

(75) Inventors: Sae Kyoung KANG, Daejeon-city (KR); Hyunwoo Cho, Daejeon-city (KR); Sang-Kyu Lim, Daejeon-city (KR); Je Soo Ko, Daejeon-city (KR)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Electronics and Telecommunications Research Institute, Daejeon-city (KR)

(21) Appl. No.: 11/868,479

(22) Filed: Oct. 6, 2007

(30) Foreign Application Priority Data
Dec. 8, 2006 (KR) 10-2006-0125066

(51) Int. Cl. H04B 10/00

(52) U.S. Cl. 398/155

(57) ABSTRACT

Provided are an apparatus and method for generating an optical return-to-zero (RZ) signal using an electronic integrated circuit that generates an electric RZ signal. The apparatus for generating an optical RZ signal includes an electronic integrated circuit generating an electric return-to-zero (RZ) signal based on an input data signal and a clock signal, a driving amplifier amplifying the electric RZ signal, a light source outputting a carrier having a predetermined wavelength, and a modulator modulating the carrier according to the amplified RZ signal. The electronic integrated circuit can be constructed in a single electronic circuit chip, and thus the size of the optical transmission system can be reduced.

### CROSS-REFERENCE TO RELATED PATENT APPLICATION

This application claims the benefit of Korean Patent Application No. 10-2006-0125066, filed on Dec. 8, 2006, in the Korean Intellectual Property Office, the disclosure of which is incorporated herein in its entirety by reference.

### BACKGROUND OF THE INVENTION

1. Field of the Invention

The present invention relates to an apparatus and method for generating an optical return-to-zero (RZ) signal, and more particularly, to an optical RZ signal generator serving as a transmitter of a large-capacity wavelength division multiplexing (WDM) system and an optical RZ signal generating method. This work was supported by the IT R&D program of MIC/IITA. [2006-S-060-01, OTH-based 40G Multi-service Transmission Technology]

2. Description of the Related Art

As people increasingly use the Internet, communication channel capacity remarkably increases and a demand for large-capacity optical communications also increases. Accordingly, methods for raising an optical signal rate have been developed in order to increase channel capacity of optical communication. However, the optical signal rate is increased to 10 Gbps or 40 Gbps and reaches the limit. To overcome the limit of the optical signal rate, a wavelength division multiplexing (WDM) transmission technique that simultaneously transmits signals with various wavelengths through a single optical fiber has been developed.

However, the transmission of signals using a large-capacity WDM transmission system operating at higher than 10 Gbps or 40 Gbps per channel is limited by chromatic dispersion and non-linear phenomenon of optical fibers.

The non-linear phenomenon is difficult to compensate while a linear phenomenon such as chromatic dispersion is easily compensated by using a dispersion compensation fiber (DCF). Accordingly, the non-linear phenomenon in optical fibers is overcome by modulating optical signals into return-to-zero (RZ) signals robust to non-linear characteristic and transmitting the RZ signals.

FIG. 1 is a block diagram of a conventional optical RZ signal generator. Referring to FIG. 1, a non-return-to-zero (NRZ) data optical modulator 110 and a clock signal optical modulator 120 are cascade-connected to generate an optical RZ signal. However, the conventional RZ signal generator illustrated in FIG. 1 requires two optical modulators and two broadband driving amplifiers, and thus its size and manufacturing cost increase.

### SUMMARY OF THE INVENTION

The present invention provides an apparatus and method of generating an optical RZ signal for reducing signal distortion caused by non-linear characteristics of optical fibers.

The present invention reduces the size of an optical transmission system by integrating components of the optical transmission system into a single electronic circuit chip.

According to an aspect of the present invention, there is provided an apparatus for generating an optical RZ signal, which comprises an electronic integrated circuit generating an electric return-to-zero (RZ) signal based on an input data signal and a clock signal, a driving amplifier amplifying the electric RZ signal, a light source outputting a carrier having a predetermined wavelength, and a modulator modulating the carrier according to the amplified RZ signal.

According to another aspect of the present invention, there is provided a method for generating an optical RZ signal, comprising generating an electric return-to-zero (RZ) signal based on an input data signal and a clock signal, amplifying the electric RZ signal, outputting a carrier having a predetermined wavelength, and modulating the carrier according to the amplified RZ signal.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a conventional optical return-to-zero (RZ) signal generator;

FIG. 2 illustrates a configuration of an optical RZ signal generator using an electronic integrated circuit that generates an electric RZ signal according to an embodiment of the present invention;

FIG. 3 illustrates a transfer characteristic curve of the electronic integrated circuit having a full-wave rectifying transfer function, illustrated in FIG. 2;

FIG. 4 illustrates waveforms of signals at each component in the optical RZ signal generator illustrated in FIG. 2; and

FIG. 5 is a flow chart of a method of generating an optical RZ signal according to an embodiment of the present invention.

### DETAILED DESCRIPTION OF THE INVENTION

The present invention will now be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art. Throughout the drawings, like reference numerals refer to like elements.

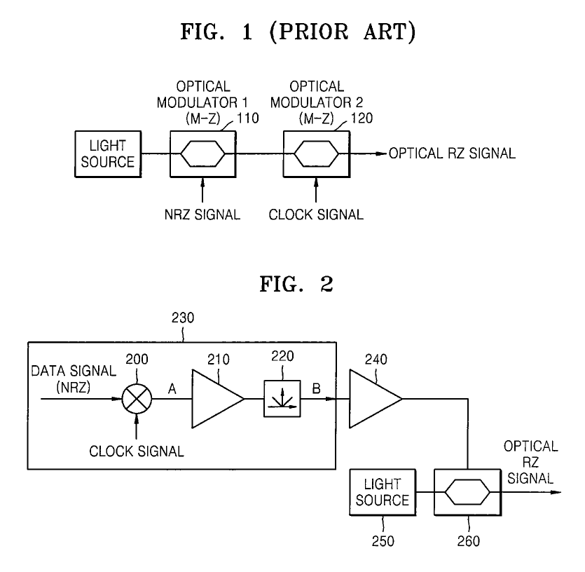

FIG. 2 illustrates a configuration of an optical RZ signal generator using an electronic integrated circuit 230 that generates an electric RZ signal according to an embodiment of the present invention. Referring to FIG. 2, the optical RZ signal generator according to an embodiment of the present invention includes the electronic integrated circuit 230, a driving amplifier 240, a light source 250, and a Mach zhender optical modulator 260.

The electronic integrated circuit 230 includes a signal mixer 200 for electrically mixing an input non-return-to-zero (NRZ) data signal with a clock signal, a signal controller 210 that is located between the signal mixer 200 and a full-wave rectifier 220 having a full-wave rectifying transfer function and amplifies the output signal of the signal mixer 200 to a sufficient amplitude or matches the number of outputs of the signal mixer 200 with the number of inputs of the full-wave rectifier 220, and a full-wave rectifier 220 having a full-wave rectifying transfer function to shift the phase of the output signal. The electronic integrated circuit 230 generates an electric RZ signal. Specifically, the signal controller 210 matches the number of outputs of the signal mixer 200 with the number of inputs of the full-wave rectifier 220 through a single signal line or two signal lines (differential signal lines) electrically connecting the signal mixer 200 to the signal controller 210 and electrically connecting the signal controller 210 to the full-wave rectifier 220. When the signal mixer 200 is connected to the signal controller 210 through two signal lines (differential signal lines) and the signal controller 210 is connected to the full-wave rectifier 220 through a single signal line or the signal mixer 200 is connected to the signal controller 210 through a single signal line and the signal controller 210 is connected to the full-wave rectifier 220 through differential signal lines, the signal controller 210 converts the signal output from the signal mixer 200 through the differential signal lines into a signal corresponding to a single signal line or converts the signal output from the signal mixer 200 through a single signal line into a signal corresponding to differential signal lines to match the number of outputs of the signal mixer 200 with the number of inputs of the full-wave rectifier 220.

The driving amplifier 240 amplifies a signal input thereto to a sufficient amplitude and drives the Mach zhender optical modulator 260. The light source 250 outputs a carrier. The Mach zhender optical modulator 260 modulates the carrier output from the light source 250 according to the electric RZ signal generated by the electronic integrated circuit 230.

The operation principle and operating method of the optical RZ signal generator using the electric integrated circuit that generates an electric RZ signal according to an embodiment of the present invention will now be explained in more detail.

Referring to FIG. 2, the signal mixer 200 electrically mixes the input NRZ data signal that is an electric signal with the clock signal having a frequency corresponding to half the transfer rate of the NRZ data signal and outputs the mixed signal. The waveform of the signal output from the signal mixer 200 at a node A is illustrated in FIG. 4. The waveform of the output signal of the signal mixer 200 at the node A has three levels +1, 0 and −1.

The signal controller 210 amplifies the output signal of the signal mixer 200 to a sufficient amplitude. The signal controller 210 is located between the signal mixer 200 and the full-wave rectifier 220 having a full-wave rectifying transfer function and matches the number of outputs of the signal mixer 200 with the number of inputs of the full-wave rectifier 220.

The signal controller 210 matches the number of outputs of the signal mixer 200 with the number of inputs of the full-wave rectifier 220 by electrically converting a single signal line to a single signal line, a single signal line to a differential signal line, a differential signal line to a differential signal line, or a differential signal line to a single signal line.

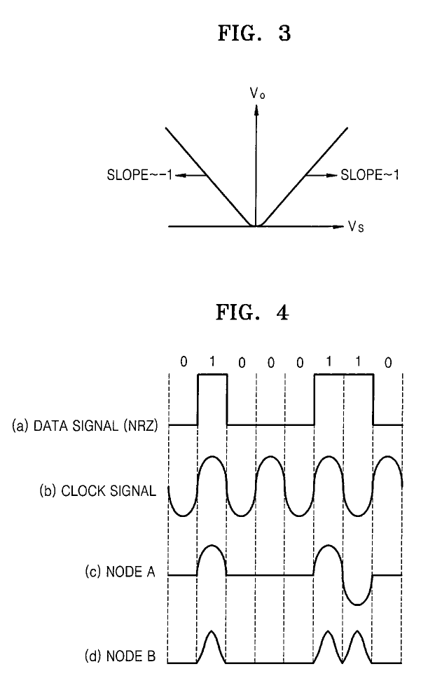

The full-wave rectifier 220 inverts the section of the output signal of the signal controller 210, which has a negative voltage, according to the transfer characteristic illustrated in FIG. 3. The waveform of the output signal of the full-wave rectifier 220 at a node B is illustrated in FIG. 4. As illustrated in FIG. 4, the signal at the node B corresponds to the electric RZ signal.

The driving amplifier 240 sufficiently amplifies the electric RZ signal generated by the electronic integrated circuit 230 such that the amplified RZ signal meets the input condition of the Mach zhender optical modulator 260 and drives the Mach zhender optical modulator 260.

The light source 250 outputs a carrier having a specific wavelength. The light source 250 may be configured in the form of a laser diode. The Mach zhender optical modulator 260 modulates the carrier output from the light source 250 into an optical RZ signal according to the electric RZ signal amplified by the driving amplifier 240.

While FIG. 2 illustrates that a single signal is transmitted between blocks of the electronic integrated circuit 230, differential signals can be also transmitted between blocks.

FIG. 3 illustrates a transfer characteristic curve of the electronic integrated circuit 230 having a full-wave rectifying transfer function, illustrated in FIG. 2. The full-wave rectifier 220 having the full-wave rectifying transfer function inverts the negative voltage section of the output signal of the signal controller 210 according to the transfer characteristic illustrated in FIG. 3. The waveform of the output signal of the full-wave rectifier 220 at the node B is illustrated in FIG. 4.

FIG. 4 illustrates waveforms of signals transmitted in the optical RZ signal generator illustrated in FIG. 2. In FIG. 4, (a) represents the NRZ data signal input to the signal mixer 200, (b) represents the clock signal, (c) represents the output signal of the signal mixer at the node A, and (d) represents the output signal of the full-wave rectifier 220 at the node B. The signal mixer 200 electrically mixes the electric input NRZ data signal with the clock signal having a frequency corresponding to half the frequency of the NRZ data signal and outputs the mixed signal. The waveform of the signal at the node A has three levels +1, 0 and −1. It can be confirmed from FIG. 4 (d) that the negative voltage section of the output signal of the signal mixer 200 is inverted so that full-wave rectification is made.

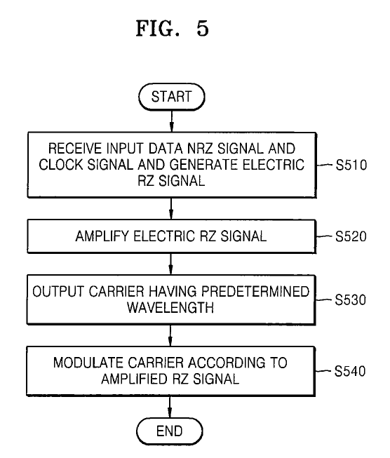

FIG. 5 is a flow chart of a method of generating an optical RZ signal according to an embodiment of the present invention. Referring to FIGS. 2 and 5, the electronic integrated circuit 230 generates the electric RZ signal based on the input data signal and the clock signal in operation S510. The driving amplifier 240 amplifies the electric RZ signal in operation S520. The light source 250 outputs a carrier having a predetermined wavelength belonging to a WDM wavelength band in operation S530. The external Mach zhender optical modulator 260 directly modulates the carrier according to the amplified electric RZ signal to generate the optical RZ signal in operation S540.

As described above, the present invention can easily generate an optical RZ signal using the electronic integrated circuit generating an electric RZ signal and a single Mach zhender optical modulator. Furthermore, the present invention can reduce the size of an optical transmission system by integrating the components of the optical transmission systems into a single integrated circuit.

While the present invention has been particularly shown and described with reference to exemplary embodiments thereof, it will be understood by those of ordinary skill in the art that various changes in form and details may be made therein without departing from the spirit and scope of the present invention as defined by the following claims.

It will be understood by those skilled in the art that the present invention is embodied as software or hardware using a general programming technique.

The invention can be also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD_ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

What is claimed is:

1. An optical RZ signal generator comprising:
an electronic integrated circuit generating an electric return-to-zero (RZ) signal based on an input data signal and a clock signal;
a driving amplifier amplifying the electric RZ signal;
a light source outputting a carrier having a predetermined wavelength; and
a modulator modulating the carrier according to the amplified RZ signal.

2. The optical RZ signal generator of claim 1, wherein the electronic integrated circuit comprises:
a signal mixer electrically mixing the input data signal with the clock signal;
a signal controller amplifying the output signal of the signal mixer; and
a full-wave rectifier inverting a negative voltage section of the output signal of the signal controller such that the output signal of the signal controller has a single polarity.

3. The optical RZ signal generator of claim 1, wherein the clock signal has a frequency corresponding to half the frequency of the input data signal and the electric RZ signal has three voltage levels.

4. The optical RZ signal generator of claim 1, wherein the input data signal is an NRZ signal and the modulator is an external Mach zhender modulator.

5. The optical RZ signal generator of claim 1, wherein the electronic integrate circuit is constructed in a single electronic circuit chip.

6. The optical RZ signal generator of claim 2, wherein the signal controller is located between the signal mixer and the full-wave rectifier and matches the number of outputs of the signal mixer with the number of inputs of the full-wave rectifier.

7. A method for generating an optical RZ signal, comprising:
generating an electric return-to-zero (RZ) signal based on an input data signal and a clock signal;
amplifying the electric RZ signal;
outputting a carrier having a predetermined wavelength; and
modulating the carrier according to the amplified RZ signal.

8. The method of claim 7, wherein the generating of the electric RZ signal comprises:
electrically mixing the input data signal with the clock signal;
amplifying the mixed signal; and
inverting a negative voltage section of the amplified signal such that the amplified signal has a single polarity.

9. The method of claim 7, wherein the clock signal has a frequency corresponding to half the frequency of the input data signal and the electric RZ signal has three voltage levels.

10. The method of claim 7, wherein the input data signal is an NRZ signal and the carrier is modulated by an external Mach zhender modulator.
